(19) United States
(12) Patent Application Publication
(10) Pub. No.: US 2006/0011599 A1
(43) Pub. Date: Jan. 19, 2006

(54) De-icing cable jig construction

(76) Inventor: William Louis Graves, Leadville, CO (US)

Correspondence Address: STURM & FIX LLP, 206 SIXTH AVENUE, SUITE 1213, DES MOINES, IA, 50309-4076, US

(21) Appl. No.: 10/894,181

(22) Filed: Jul. 19, 2004

(51) Int. Cl. H05B 1/00

(52) U.S. Cl. 219/213

(57) ABSTRACT

A de-icing cable jig construction (10) for a floating membrane roof drain (100) provided with a clamping collar (110) and a domed strainer (120) wherein, the jig construction (10) includes a base plate member (20) provided with drainage slots (22) and track arm recesses (21) that are adapted to receive a plurality of track arms (31) projecting radially outwardly from a hub member (30) wherein, the track arms (31) are provided with sleeve elements (32) that define track channels for an elongated length of heating cable (40) arranged into horizontal heating cable loops (41).

### CROSS REFERENCE TO RELATED APPLICATIONS

This invention was the subject matter of Document Disclosure Program Registration Number 546,767, filed in the United States Patent and Trademark Office on Feb. 13, 2004.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of roof de-icing arrangements in general and in particular to a de-icing apparatus that can be retrofitted onto existing roof drain constructions.

2. Description of Related Art

As can be seen by reference to the following U.S. Pat. Nos. 3,784,783; 3,816,687; 6,225,600; 5,960,590; and, 4,333,444, the prior art is replete with myriad and diverse snow and ice melting arrangements for roofs, gutters, drains and the like.

While all of the aforementioned prior art constructions are more than adequate for the basic purpose and function for which they have been specifically designed, they are uniformly deficient with respect to their failure to provide a simple, efficient, and practical de-icing arrangement that is adapted to be secured to existing drain components for a floating membrane roof where penetrating anchors cannot be employed.

As most building owners and roofing contractors in cold weather climates are all too well aware, ice dams are an ever present danger during the winter months wherein, undue stress loads are placed on generally flat roof constructions.

As a consequence of the foregoing situation, there has existed a longstanding need for a new and improved de-icing cable jig construction that can be retrofitted onto existing conventional roof drain constructions, as well as, installed as original equipment on new floating membrane roofs, and the provision of such a construction is a stated objective of the present invention.

### BRIEF SUMMARY OF THE INVENTION

Briefly stated, the de-icing cable jig construction that forms the basis of the present invention is specifically designed for use with floating membrane roof drains provided with a conventional clamping collar and strainer.

As will be explained in greater detail further on in the specification, the cable jig construction comprises in general a base plate unit, a cable track unit and a heater cable unit that are operatively disposed intermediate a conventional roof drain, and a membrane clamping collar and strainer arrangement.

The base plate unit is provided with a first plurality of enlarged track arm recesses that are dimensioned to receive the plurality of adjustable track arms of the cable track unit and a second plurality of radial drainage slots wherein, the base plate unit assumes the role of the prior art clamping collar on existing floating member roof surfaces.

In addition, each of the track arms of the track unit defines a pair of heating cable channels dimensioned to receive individual horizontal heating cable loops wherein, the track unit further includes a central hub element dimensioned to receive a downwardly depending vertical heating cable loop that extends through the mouth of the drain pipe.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the de-icing cable jig construction installed on a floating membrane roof surface;

FIG. 2 is a cross-sectional view taken through line 2-2 of FIG. 1;

FIG. 3 is an exploded perspective view of the cable jig construction and conventional roof drain components;

FIG. 4 is an isolated perspective view of the cable track unit and the heating cable unit as viewed from above;

FIG. 5 is a cross-sectional view taken through line 5-5 of FIG. 4;

FIG. 6 is an isolated perspective view similar to FIG. 4, but viewed from below; and,

FIG. 7 is a perspective view of the structural components of the jig construction in combination with the prior art clamping collar.

### DETAILED DESCRIPTION OF THE INVENTION

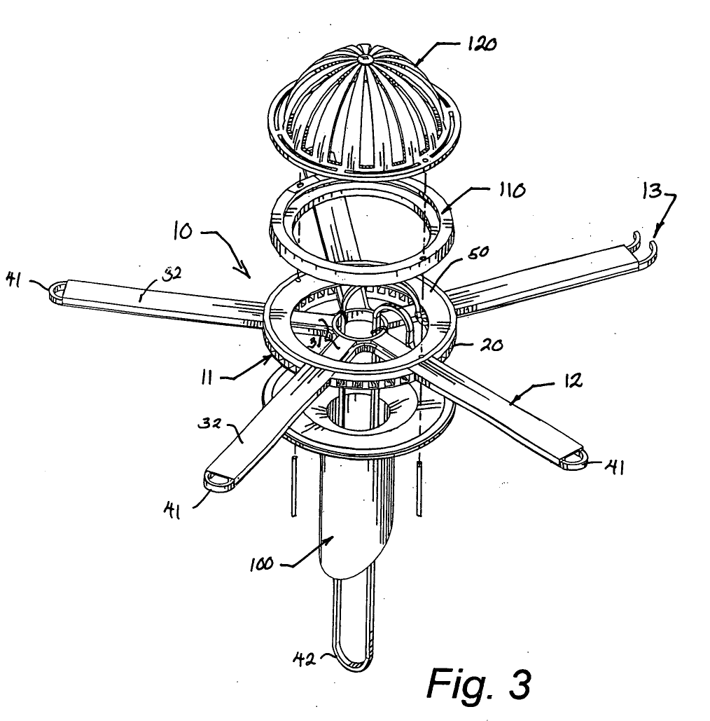

As can be seen by reference to the drawings, and in particularly to FIG. 3, the de-icing cable jig construction that forms the basis of the present invention is designated generally by the reference number 10. The construction 10 comprises in general a base plate unit 11, a cable track unit 12 and a heating cable unit 13 employed in combination with a conventional floating membrane roof drain 100, a conventional clamping collar 110 and a conventional domed strainer 120. The aforementioned units will now be described in seriatim fashion.

As can best be seen by reference to FIG. 7, the base plate unit 11 comprises a circular base plate member 20 provided with a first plurality of enlarged track arm recesses 21 and a second plurality of drainage slots 22 arranged in a radial fashion around an enlarged central base plate opening 23.

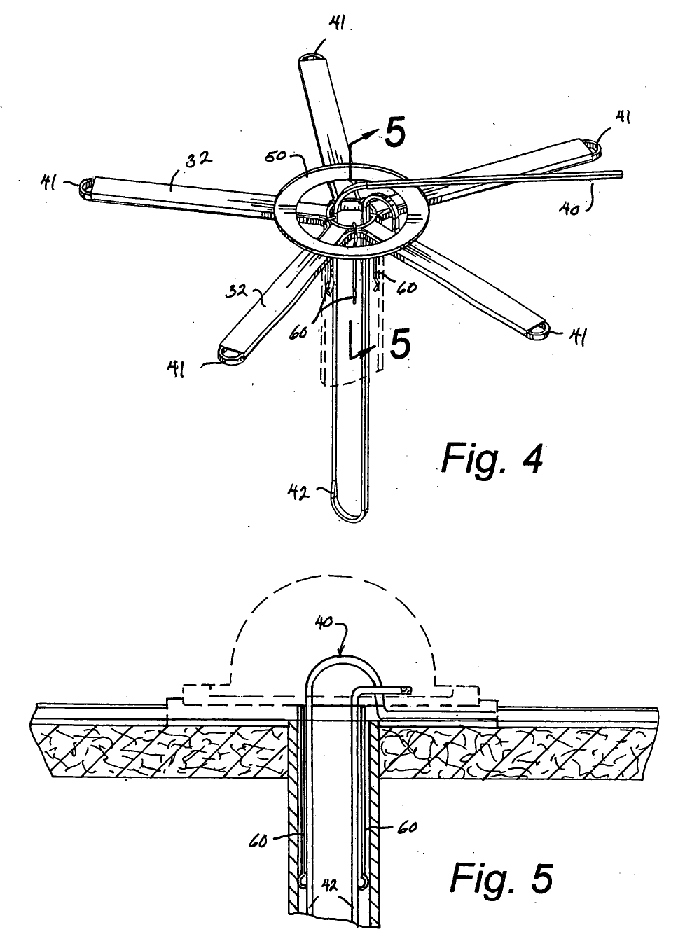

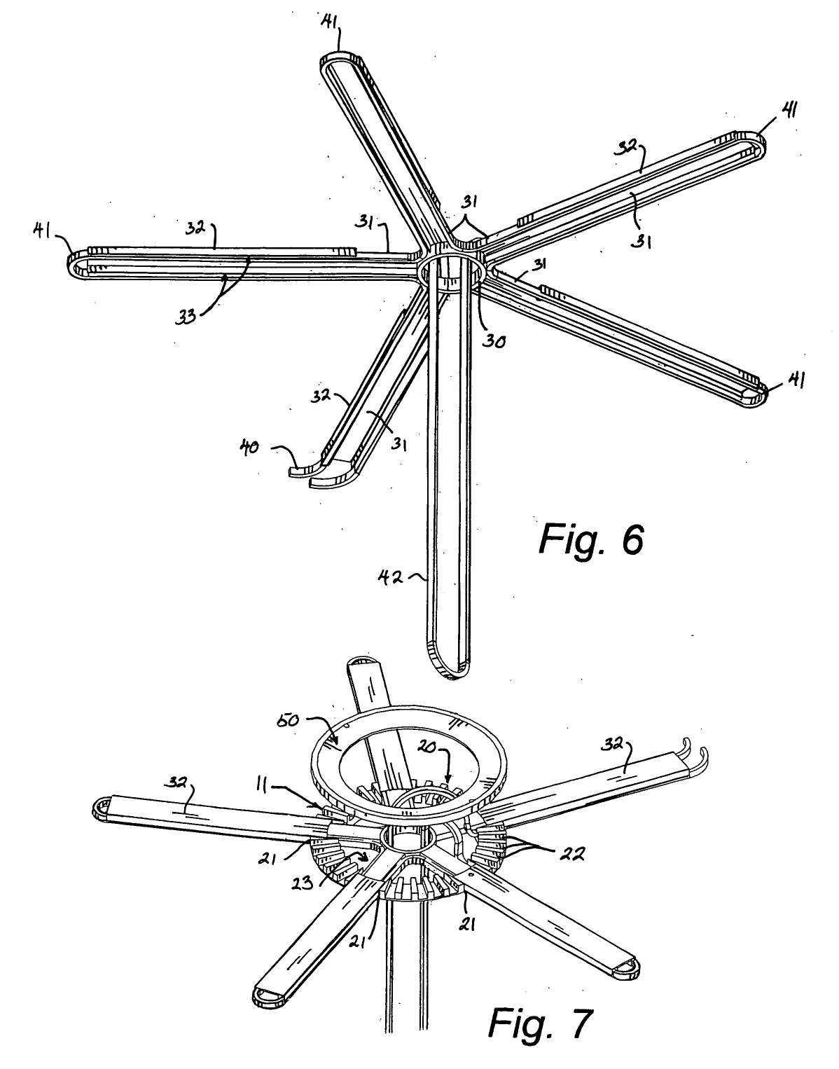

In addition, as can be seen by reference to FIGS. 4, 6 and 7, the cable track unit 12 includes a hollow hub member 30 provided with a plurality of radial track arms 31 wherein, each of the track arms 31 is provided with an adjustable outer sleeve element 32 wherein, the exterior surface of the sides of the track arms 31 and the interior surface of the sides of the sleeve elements 32 define a pair of cable track channels 33 the purpose and function of which will be described in greater detail further on in the specification.

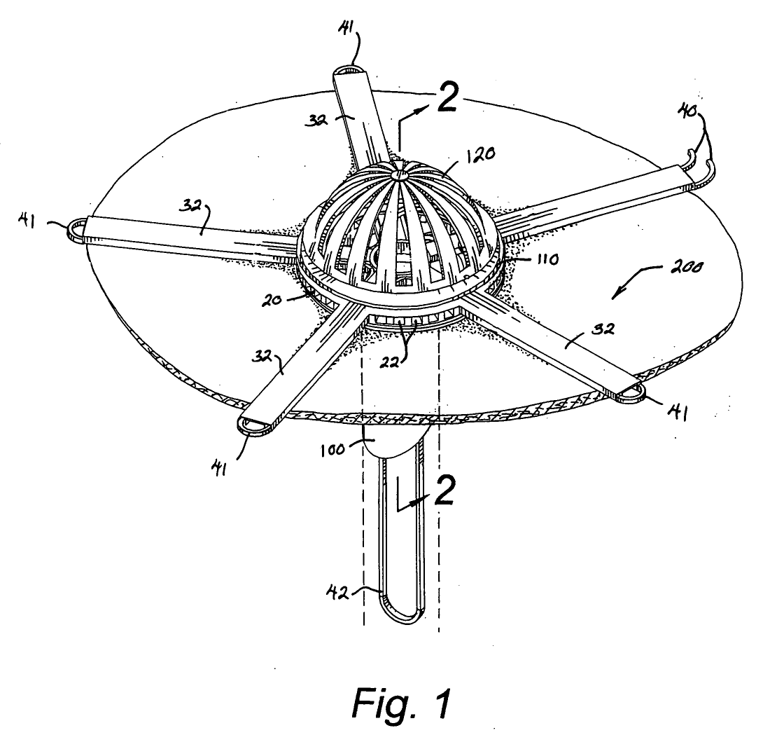

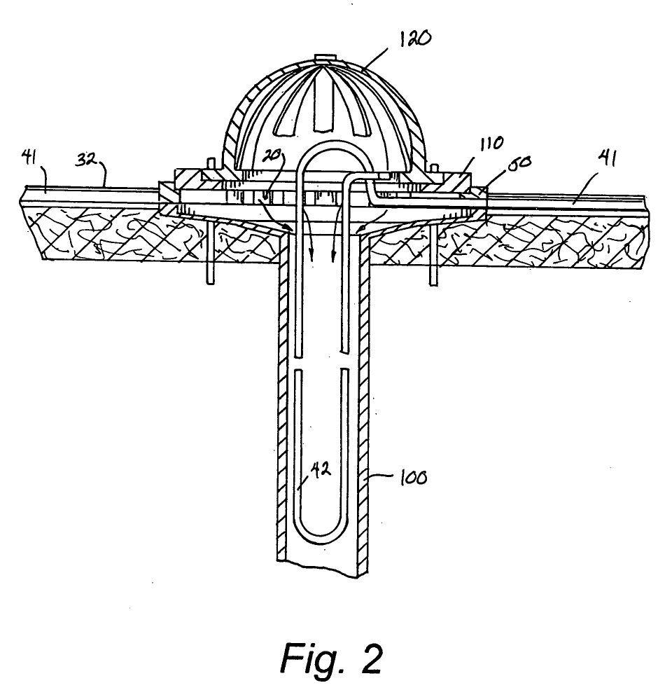

Turning now to FIGS. 1 through 4 and 6, it can be seen that the heating cable unit 13 comprises an elongated length of heating cable 40 that is threaded into the channel tracks 33 between the radial arms 31 and radial sleeve elements 32 to define a plurality of horizontally arrayed heating cable loops 41 41 and wherein, the heating cable 40 is further threaded through the hub member 30 of the cable track unit 12 to define a vertically oriented downwardly depending cable loop 42 that extends into the conventional drain pipe 100 to prevent ice buildup in the mouth and throat portions of the drain pipe 100.

Furthermore, as can be seen by reference to FIGS. 3, 4 and 7, this invention also contemplates the provision of a cap plate member 50 that cooperates with the base plate member 20 to captively engage the cable track unit 12 intermediate the clamping collar with the associated 110 domed strainer 120 and the roof drain 100 which are normally directly connected to one another in a well recognized fashion.

As can also be appreciated by references to FIGS. 4 and 5, this invention also contemplates the provision of alignment tines 60 that are operatively associated with both the base plate member 20 and the cap plate member 50 to align the apparatus 10 with the mouth of the drain pipe 100.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A de-icing cable jig construction for use with a conventional floating membrane roof drain having a clamping collar and a domed strainer wherein, the construction comprises
a base plate unit including a base plate member provided with a first plurality of enlarged recesses and a second plurality of drainage slots wherein, the base plate member is adapted to be connected to the roof drain;
a cable track unit including a hollow hub member provided with a plurality of radial track arms that are dimensioned to be received in said first plurality of enlarged recesses in the base plate member; and,
a heating cable unit including an elongated length of heating cable that is arranged into a plurality of horizontal heating cable loops associated with selected ones of the plurality of radial track arms.

2. The construction of claim 1; wherein, the elongated length of cable is further arranged into a vertically oriented downwardly depending heating cable loop that is threaded through said hollow hub member.

3. The construction as in claim 1; wherein, said domed strainer is connected to said clamping collar which in turn is connected directly to the base plate unit to captively engage the cable track unit to the base plate unit.

4. The construction as in claim 1 further comprising a cap plate member that is connected to the base plate unit to captively engage the cable track unit between the cap plate member and the base plate member.

5. The construction as in claim 1; wherein, the cable track unit further includes a plurality of track arms wherein, the exterior surface of the sides of each track arm and the interior surface of the sides of the sleeve elements form a pair of cable track channels that are dimensioned to receive portions of the horizontal heating cable loops.

6. The construction as in claim 2; wherein, the cable track unit further includes a plurality of track arms wherein, the exterior surface of the sides of each track arm and the interior surface of the sides of the sleeve elements form a pair of cable track channels that are dimensioned to receive portions of the horizontal heating cable loops.

7. The construction as in claim 3; wherein, the cable track unit further includes a plurality of track arms wherein, the exterior surface of the sides of each track arm and the interior surface of the sides of the sleeve elements form a pair of cable track channels that are dimensioned to receive portions of the horizontal heating cable loops.

8. The construction as in claim 4; wherein, the cable track unit further includes a plurality of track arms wherein, the exterior surface of the sides of each track arm and the interior surface of the sides of the sleeve elements form a pair of cable track channels that are dimensioned to receive portions of the horizontal heating cable loops.

9. The construction as in claim 4; wherein, the domed strainer is connected to the said clamping collar which in turn is connected directly to said cap plate member.

10. The construction as in claim 9; wherein, the cable track unit further includes a plurality of track arms wherein, the exterior surface of the sides of each track arm and the interior surface of the sides of the sleeve elements form a pair of cable track channels that are dimensioned to receive portions of the horizontal heating cable loops.
